(19) United States
(12) Patent Application Publication
(10) Pub. No.: US 2026/0349179 A1
(43) Pub. Date: Nov. 5, 2026

(54) RING RESONATOR BASED IQ MODULATORS

(71) Applicant: PILOT PHOTONICS LIMITED, Dublin (IE)

(72) Inventors: Andrew Ellis, Dublin (IE); Frank Smyth, Dublin (IE)

(21) Appl. No.: 19/120,657

(22) PCT Filed: Oct. 16, 2023
(86) PCT No.: PCT/EP2023/078685

§ 371 Date: Apr. 11, 2025

(30) Foreign Application Priority Data
Oct. 14, 2022 (GB) 2215209.4

(51) Int. Cl. G02B 6/293; G02F 1/01; G02F 1/21; G02F 1/225; H04B 10/50

(52) U.S. Cl. CPC G02B 6/29343; G02F 1/0123; G02F 1/212; G02F 1/225; H04B 10/5051

(57) ABSTRACT

Disclosed is a cascaded ring resonator structure, that comprises a pair of ring modulators connected in series, each ring modulator of the pair being driven by first and second drive voltages respectively for generating a chirp-free output signal, and wherein the first and second drive voltages have opposite polarities and are in a predetermined ratio. An IQ modulator superstructure is also described.

### CLAIM OF PRIORITY

This application is the U.S. National Stage of International Patent Application No. PCT/EP2023/078685 filed 16 Oct. 2023, which claims priority to United Kingdom Patent Application No. GB 2215209.4 filed 14 Oct. 2023, the entire content of these applications being incorporated herein by reference as if fully set forth below in their entirety and for all applicable purposes.

### FIELD

The present disclosure is directed towards IQ modulators, and more particularly to a cascaded ring resonator structure and ring resonator based IQ modulators.

### BACKGROUND

The use of coherent detection for high data rate applications in short reach transmission systems is increasingly compelling for all modulation formats due to the sensitivity advantage offered by coherent gain. This gain is provided in a small volume, requiring only the addition of a local oscillator laser and a passive coupler or hybrid. For intensity modulated formats, envelope detection may be used to retain most of the sensitivity benefit of coherent gain without the requirement for DSP. However, the advantage is increased with full processing of the optical field, which also enables capacity increase through phase and polarisation diversity.

Similarly, non-binary digital modulation is increasingly attractive, with PAM-4 and PAM-8 formats employed in direct detection applications, and various forms of QAM proposed for coherent detection applications. Whilst PSK may be employed, offering great simplicity and potentially more than 2 bits per symbol, commercial use of PSK is surprisingly infrequent, with PAM and QAM formats being preferred. In both cases linear, low chirp, modulation of the optical field is preferred. Linear modulation enables the desired intensity (direct detection) or amplitude (coherent detection) spacing of constellation points to be readily achieved. Low chirp is preferred for directly detected PAM signalling to maximise chromatic dispersion tolerance, whilst for QAM it is required to ensure uniform constellations (maximum distance between adjacent constellation points). Direct modulation of a laser offers the highest optical power efficiency, but generally results in a trade-off between linearity and extinction ratio, and is often beset with chirp, reducing the suitability for QAM formats. Consequently, external modulation is often employed, where an example of external modulation is absorption or loss modulation, which is typically implemented typically with an Electro-absorption modulator (EAM) or an integrated laser modulator (ILM). For the generation of QAM modulation using EAMs, a three-arm interferometer may be employed (with optimised phase shifts) with one EAM allocated to generating a PAM modulation in each quadrature, resulting in a QAM constellation offset into the positive real quadrant of the complex plane, and the third arm providing a signal to interferometrically remove this offset (if required).

Another type of external modulation is phase modulation, mainly important for phase modulation-based generation of PAM and QAM formats, and where an interferometric structure is required to generate intensity modulation. Typically, a Mach Zehnder structure is employed giving rise to a sinusoidal transfer function with zero chirp in the ideal case of a perfect push-pull modulator. Alternatively, a ring resonator interferometer may be used, giving a highly nonlinear and chirped modulation response but benefiting from multiple passes through each phase modulator and so reducing the required drive voltage and/or device size. Both interferometer structures may be implemented in any suitable material system.

Consequently Lithium Niobate (dominated by dc Kerr effect) and GaAs (dominated by the linear electrooptic effect of the Quantum Confined Stark Effect) modulators are typically Mach Zehnder structures and InP (dominated by modulation of the band edge) is employed either as an EAM (signal coincident with the band edge) or in a MZM (signal detuned from the band edge) structure.

Traditionally, RR have not been used for QAM modulation, with only a small number of research papers reporting complicated structures based on RR. For PAM formats, RR modulators may be favoured to enable the benefits of silicon photonics (wafer size, yield, synergy with electronic fabrication techniques—and so low cost) at the expense of nonlinear transfer functions and chirp. Further, whilst the RR modulators are traditionally fabricated in silicon photonics, however, there is no fundamental reason why a particular design should be favoured for a particular material system, for example MZM based silicon modulators are now emerging.

FIG. 1 illustrates transfer functions 102 and 104 of MZM and RR modulators respectively, showing their respective amplitudes 102a and 104a and phases 102b and 104b. FIG. 1 further illustrates transfer functions 106 and 108 of MZM and RR modulators in the complex plane respectively with a Pi/4 phase offset in the case of the MZM for clarity. The amplitude nonlinearity of both the MZM and RR is apparent, and the additional chirp of the RR modulator is clearly shown. The characteristics of MZM modulator includes that it has Linear transfer at low drive voltage, low (zero) chirp, deterministic nonlinearity at high drive voltage. Furthermore, the bandwidth is determined primarily by velocity matching and electrode loss. They operate of a wide wavelength range but have a relatively large size and require a relatively high drive voltage. The RR modulator has a complex transfer function (approximately circular on the complex plane), high chirp and low drive voltage, capacitive (small) or transmission line electrical bandwidth limitations, wavelength selectivity, and an impulse response complicated by wavelength selectivity.

Transmitters based on MZM have been commercially available for over two decades, coming in three flavours—discrete components, for example InP lasers and LiNbO3 modulators with obvious cost drawbacks, heterogenous integration, such as InP lasers and thin film (LiNbO3) modulators presenting challenging fabrication, or homogenously integrated such as InP lasers and InP modulators, where, even with careful bandgap control, unwanted effects such as absorption in the modulator degrade the performance. Overall, however, MZM based systems are large compared to other active components, such as lasers and optical amplifiers, reducing the number of integrated circuits per wafer. This is because either the electro-optic interaction is weak, requiring a long interaction length at practical drive voltages. By recirculating the signal through the same section of waveguide multiple times, the RR neatly overcomes the size restriction, but clearly as shown above reduces the performance for the QAM modulation formats required in today's transmission systems.

Hence, in view of the above, there is need for a system and method that simultaneously retains the size benefits of the RR and the performance benefits of the MZM.

### SUMMARY

According to the invention there is provided, as set out in the appended claims, a cascaded ring resonator structure or system, comprising a pair of ring modulators connected in series, each ring modulator of the pair being driven by first and second drive voltages respectively for generating a chirp-free output signal, and wherein the first and second drive voltages have opposite polarities and are in a predetermined ratio.

In one embodiment, the pre-determined ratio is greater than 0 and less than or equal to 1.

In one embodiment, the pair of identical ring modulators operate in an ideal push-pull configuration, when the pre-determined ratio is one.

In one embodiment each ring modulator of the pair operate in a golden ring configuration, when corresponding absorption co-efficient is similar to corresponding ring coupling efficient.

In one embodiment, each ring modulator of the pair operate in a silver ring configuration, when absorption co-efficient of each of the first through fourth ring modulators is greater than corresponding ring coupling efficient.

In one embodiment, there is provided an IQ modulator superstructure, comprising: an upper arm including a cascaded ring resonator structure as claimed in any of claims 1 to 5, and driven by in-phase components of first and second drive voltages for generating a chirp-free in-phase output signal; and a lower arm including the cascaded ring resonator structure as claimed in claims 1-5, and driven by quadrature components of first and second drive voltages for generating a chirp-free quadrature output signal, wherein the in-phase and quadrature output signals combine to generate a chirp-free rectangular QAM signal.

In one embodiment, the IQ modulator superstructure comprises a third unmodulated arm between the upper and lower arms, to provide a DC bias to negate a DC offset of the chirp-free rectangular QAM signal, and centre a constellation diagram of the chirp-free QAM signal on the origin.

In one embodiment, the third unmodulated arm comprises a passive waveguide and a phase shifter.

In one embodiment, the ring coupling co-efficients of the cascaded ring resonators of the upper and lower arms are tuned to generate a desired amplitude of the rectangular QAM signal.

In one embodiment the third arm includes a single ring to modulate an amplitude of the chirp-free rectangular QAM signal.

### BRIEF DESCRIPTION OF THE DRAWINGS

The invention will be more clearly understood from the following description of an embodiment thereof, given by way of example only, with reference to the accompanying drawings, in which:

FIG. 1 illustrates transfer functions of MZM and RR modulators respectively, showing their respective amplitudes and phases.

FIG. 2 illustrates Interferometer superstructures typically used to generate QAM waveforms using MZM and RR based building blocks respectively.

FIG. 3 estimates the relative performances of MZM and RR based interferometer structures respectively.

FIGS. 4a and 4b illustrate cascaded RR structures for high order QAM generation, in accordance with an embodiment of the present invention.

FIG. 5 illustrates section of cascaded RR transfer functions for various scaling coefficients.

FIG 6a and 6b illustrate an output of proposed double ring modulator with golden ring configuration and its performance respectively.

FIG. 7 illustrates constellation diagrams for silver rings with various values of a and t, and

FIG. 8 illustrates potential push pull device configurations (assuming correct crystal orientation and Kerr effect-based modulation mechanism).

### DETAILED DESCRIPTION OF THE DRAWINGS

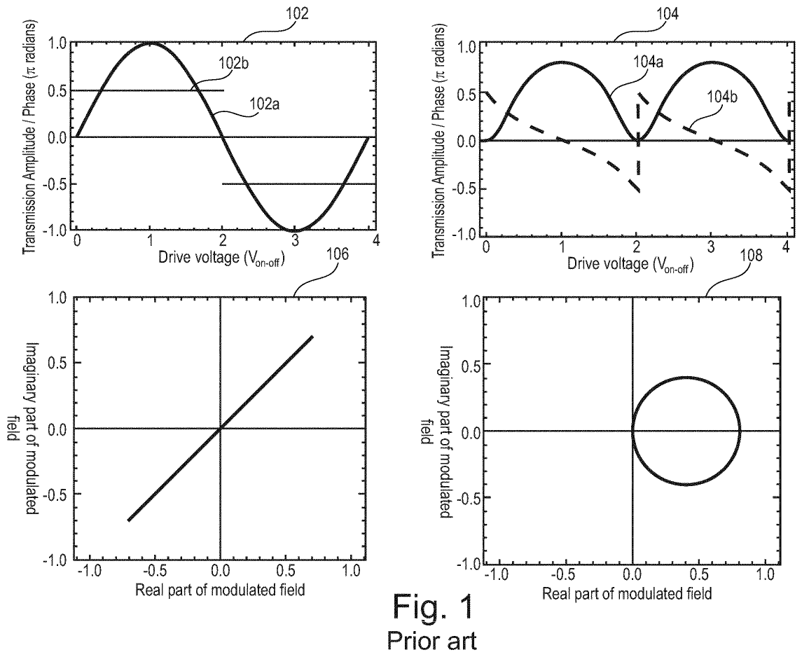

FIG. 1 illustrates the typical normalised transfer functions of MZMs (102 and 106) and RRs (104 and 108) in terms of the amplitude (102a, 104a) and phase (102b, 104b) response versus voltage (102 and 104) and their representation in the complex plane (106 and 108) where the solid lines indicate the combination of real and imaginary parts which may be achieved as the bias voltage is varied.

The curvature of the amplitude responses (102a, 104a) illustrates the nonlinear transfer function of each modulator, arising from the characteristics of the interferometer structure. The horizontal phase response (102b) and linearity of transfer characteristic (106) show the zero chirp of an ideal MZM, which the curvature in the equivalent curves for the RR (104b, 108) illustrate the inherently high chirp.

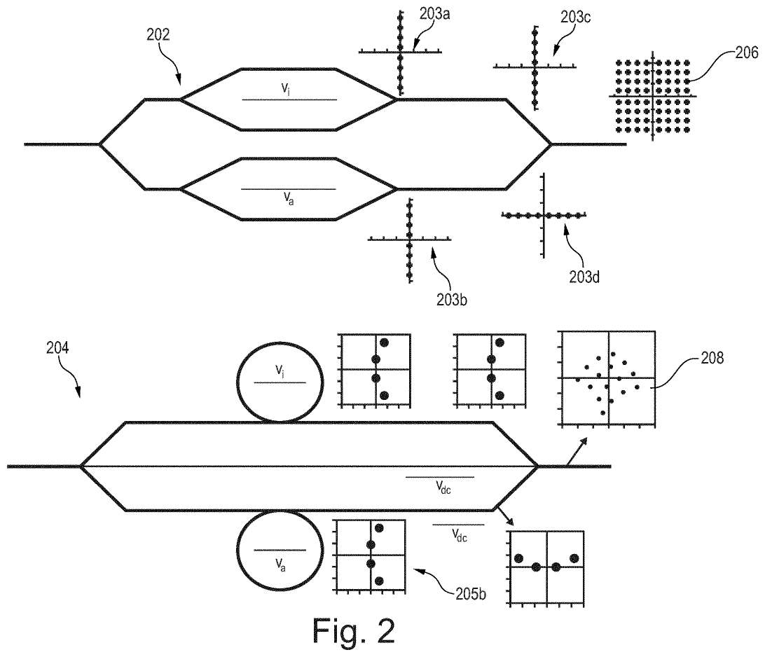

FIG. 2 illustrates Interferometer superstructures 202 and 204 typically used to generate QAM waveforms using MZM and the equivalent obvious RR based structure respectively. The Interferometer superstructure 202 shows a typical dual parallel MZM, or IQM typically implemented in Lithium Niobate. To generate a QAM signal, each sub MZM generates a balanced m-ASK signal (203a, 203b—in this case 8-QAM is generated), and phase bias added to the (in this case) lower arm of the outer interferometer (203d). At higher drive voltages, the MZM transfer function compresses the outer constellation points. When combined, the two signals generate the observed 64 QAM constellation 206. A uniform constellation is observed for drive voltages up to about 0.5 Vₚᵢ. An equivalent generation process is shown for the RR modulator-based superstructure 204. However, in this case, the generated PAM waveforms (4-PAM in this case) are chirped 205b, having both real and imaginary parts. Consequently, the generated 16-QAM signal 208 is distorted from the ideal square shape, reducing the overall system performance.

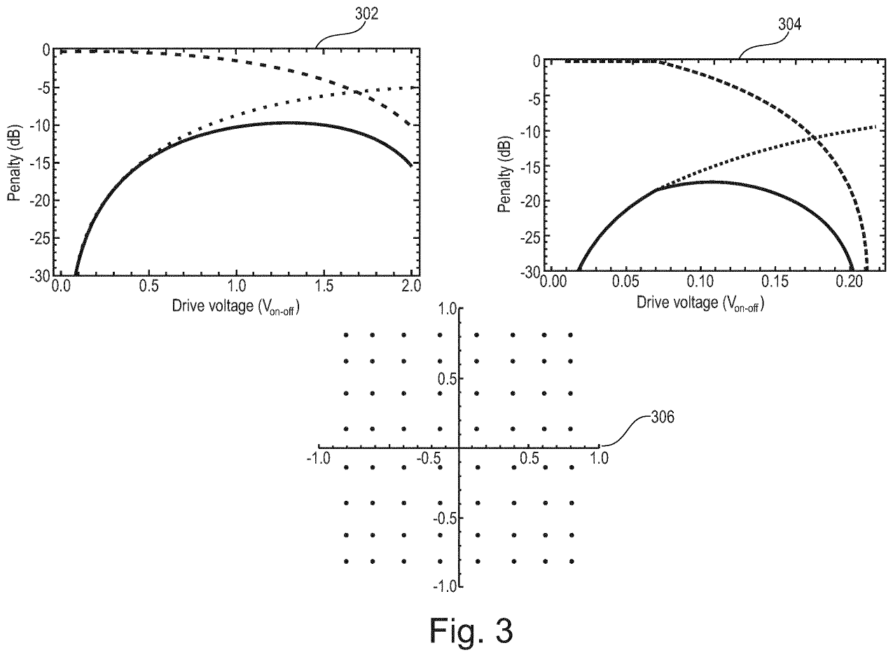

FIG. 3 estimates the relative performances 302 and 304 of MZM and RR based interferometer structures respectively. They illustrate 64QAM modulation penalty in terms of modulation loss (dotted), signal distortion (dashed) and an overall performance estimate (solid) for MZM and RR sub modulators, in an IQ superstructure and constellation diagram for MZM 306. A typical constellation diagram for the RR is shown in 208. It can be seen that MZM based IQM has a demonstrably superior performance. Clearly, in both cases, the transfer function may be calibrated and pre-compensated with digital signal processing, ideally giving zero distortion and a modulation loss determined by the ability of the structure to generate the required set of high amplitude points, which is limited by the level of accessibility to the full complex plane.

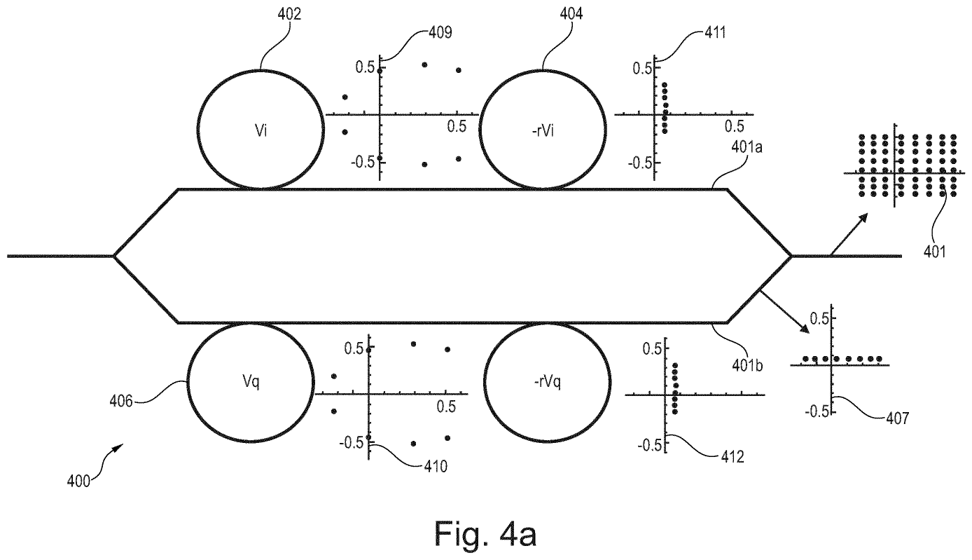

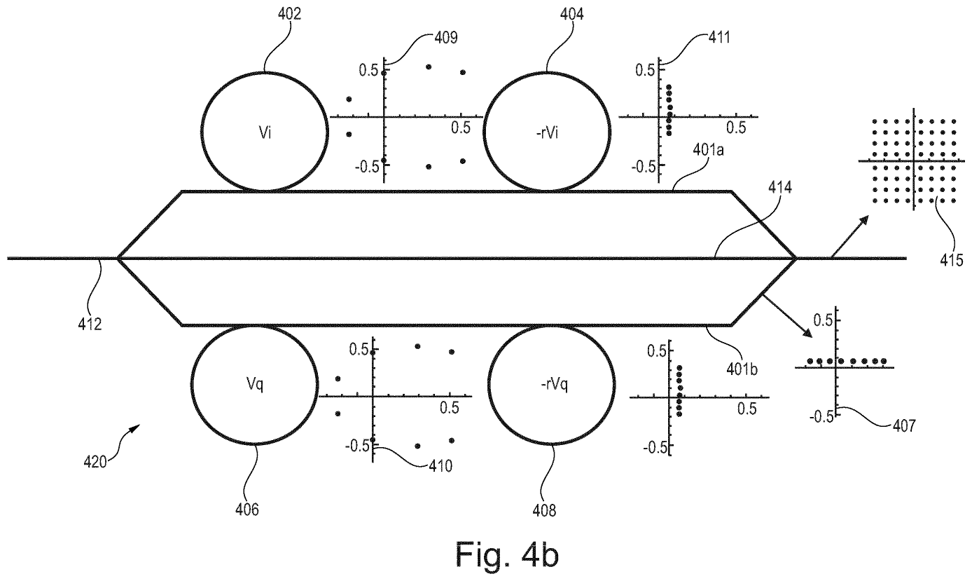

FIG. 4a illustrates an IQ modulator superstructure 400 for generating a QAM signal, in accordance with a first embodiment of the present invention. The IQ modulator superstructure 400 includes a pair of RR modulators in each arm of a MZM structure, with an example generation of a 64QAM modulation signal 401.

The IQ modulator superstructure 400 includes a pair of ring modulators in each of the top and bottom arms 401a and 401b, and is hereinafter also referred to as a dual-ring dual-parallel superstructure 400. The top arm 401a includes first and second top ring modulators 402 and 404 connected in series, and the second arm 401b includes first and second bottom ring modulators 406 and 408 connected in series. Both the top and bottom arms 401a and 401b operate in a similar manner and may be identical. Each of the ring modulators 402-408 may be hereinafter referred to as a ring or a ring resonator (RR). In an embodiment of the present invention, the first top ring 402 operates at an in-phase component Vᵢ of a first drive voltage V₁ to generate first in-phase output 409 which is chirped. The second top ring 404 operates at an in-phase component −rVᵢ of a second drive voltage −rV₁ to generate an almost chirp free in-phase output 411. Similarly, the first bottom ring 406 operates at a quadrature component V_{Q} of the first drive voltage V₁ to generate first quadrature output 410. The second bottom ring 408 operates at a quadrature component −r V_{Q} of the second drive voltage −rV1 to generate a chirp free quadrature output 412. A 90-degree phase shift may be added to the quadrature output 412 (either by design of coupler transfer function, waveguide layout, or a phase shifter (or most likely all three) to generate a horizontal quadrature output 407. With an appropriate phase bias, the chirp free in-phase and quadrature outputs 411 and 407 combine to form a 64-QAM output signal 401. The direct vector addition (two arm interferometer) generates an offset, such that, in this example, 9 points are present in the bottom left quadrant but 25 points in the top right quadrant of the output signal 401. Ideally the invention is embodied as a cascaded ring resonator structure, comprising a pair of identical ring modulators connected in series, each ring modulator of the pair being driven by first and second drive voltages respectively for generating a chirp-free output signal, and wherein the first and second drive voltages have opposite polarities and are in a predetermined ratio.

FIG. 4b illustrates an IQ modulator superstructure 420 for generating a QAM signal, in accordance with a second embodiment of the present invention. The IQ modulator superstructure 420 is similar to the IQ modulator superstructure 400 except for an additional middle arm 414 between the top and bottom arms 401a and 401b to negate the dc offset of the output signal 401. The middle arm 414 may be an additional passive waveguide. The middle arm 414 is adapted to generate a continuous wave signal which is interferometrically added to the modulated signals with the correct amplitude and phase, effectively adding an optical bias to centre the resultant constellation diagram of the 64-QAM signal 401 on the origin, thereby generating a modified quadrature output signal 415, which has 16 points present in the bottom left quadrant and 16 points in the top right quadrant. Thus, adding a third cw signal of the correct amplitude and phase generates the quadrature output signal centered at origin. It is to be noted that appropriate 1×3 and 3×1 coupler may be installed at the input and output of the structure 420 where the coupling ratio is set to obtain the correct amplitudes.

Further, when the distance between the top right and top left points is B, then for this specific configuration, the added cw signal would be given by —B/7(1+j). The two arm interferometer may be provided with a central waveguide, to have a simple electrode to provide an appropriate static phase shift.

In an embodiment of the present invention, the ratio of first and second drive voltages is referred as a scaling co-efficient r, such that the second drive voltage −rV₁ is a scaled down and inverted copy of the first drive voltage V₁.

It is known that in each arm, the transfer function for a single RR is approximately given by the following equation:

$$\frac{- {ae}^{- i π x} + t}{1 - {ae}^{- i π {x}_{t}}} \qquad ( 1 )$$

where,
X is the drive voltage, normalised to the voltage required to obtain a Pi phase shift.
a is the loss of the waveguide within the ring (absorption coefficient times ring length), and t is the ring coupling coefficient

Based on the equation (1), the transfer function of two cascaded identical RRs in each arm, is given by the following equation:

$$\frac{( a - {e}^{- i π x} t ) ( a - {e}^{- i π rx} t )}{( {e}^{i π} - at ) ( {e}^{- i π rx} - at )} \qquad ( 2 )$$

Where r is the scaling co-efficient
Typically, cascades of RR have been used to perform independent modulation of different channels, such as a cascade of amplitude and phase modulations, or to implement higher order modulation with binary drives and consequently with at least one modulator per bit, and typically use distinct modulator configurations for each format studied. In contrast, the IQ modulator superstructure 400 includes a driver function in each arm, where the second ring with a scaled and inverted copy of the first drive voltage generates a chirp-free output signal 401. This is possible because the level of amplitude and phase modulation is strongly dependent on the drive voltage. For high drive voltages, the response is mostly phase, whilst for small drive voltages, it is mostly amplitude.

At low drive voltages, the chirp means that the resultant constellation is distorted, with the level of distortion increasing with drive voltage. However, low drive voltages result in low modulated output power. This means there is a trade-off between output power and distortion and RR based IQ modulator with one ring in each arm the overall performance is significantly degraded compared to MZMs. In extreme cases of chirp, constellation points from the I and Q arms actually overlap.

The presence of the second ring in each arm, may eliminate the chirp from the first in-phase and quadrature outputs 409 and 410. Not only is the distortion very much reduced, but the modulated output power may be increased.

In an embodiment of the present invention, when the first and second ring modulators are identical in each arm, and the first and second drive voltages are equal in magnitude, but opposite in polarity, then the scaling co-efficient r=1. Such configuration is referred to as an ideal push pull configuration.

Further, it is to be noted that the golden ring is a term used to denote a ring with the maximum extinction ratio (the dip in 104a reaches the x-axis, see FIG. 1). It occurs when the parameters a and t are matched. Further, the silver ring is a term used herein to denote a ring when the ring coupling coefficient t is less than the absorption co-efficient a.

In first embodiment of the present invention, the IQ modulator superstructure 400 operates in ideal push pull configuration with four identical rings in golden ring configuration, in that r=1, and a=t. In each arm, the serially connected ring modulators may operate at similar drive voltages of opposite polarities.

In second embodiment of the present invention, the IQ modulator superstructure 400 operates with four identical rings in silver ring configuration, in that a>t. In each arm, the serially connected ring modulators may operate at similar, but not identical (r≠1), drive voltages of opposite polarities.

In another embodiment of the present invention, the IQ modulator superstructure 400 operates in golden ring configuration, with optimized scaling co-efficient, in that r<1, and a=t in each arm, but with non-identical modulators. The scaling co-efficient may be optimized to minimise the chirp at the output. In each arm, the serially connected ring modulators may operate at different drive voltages of opposite polarities.

In another embodiment of the present invention, the IQ modulator superstructure 400 operates in silver ring configuration with optimized scaling co-efficient, in that r<1, and a>t in each arm. In each arm, the serially connected ring modulators may operate at different drive voltages of opposite polarities.

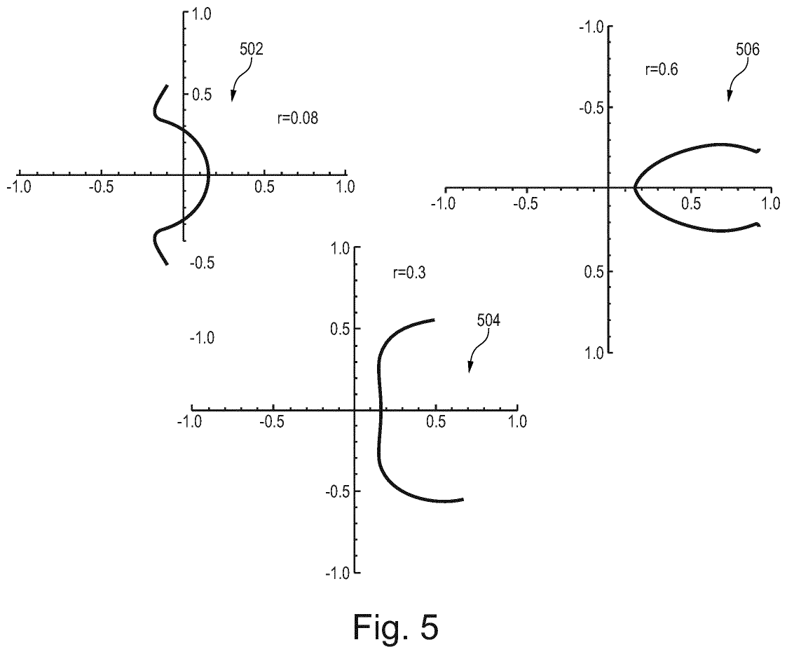

FIG. 5 shows subsets of first, second and third transfer functions 502, 504 and 506 of two identical RR in cascade with first, second and third scaling coefficients (r) 0.08, 0.3, and 0.6 respectively (t=0.7, a=0.83). It can be seen from FIG. 5, that as the scaling coefficient ‘r’ increases from zero, the transfer function is distorted from the pure circle. At an optimum point (r=0.3), almost pure amplitude modulation is possible, but above the point, the signal distortion becomes more severe. If the scaling coefficient is too small, the chirp is not compensated enough, and if the scaling co-efficient is large, chirp is overcompensated.

The offset of the transfer function from zero implies that, as with EAM based IQ modulators, the constellation would be offset from the origin as well. However, this may be trivially accommodated by the middle arm 414, i.e. a third unmodulated interferometer arm.

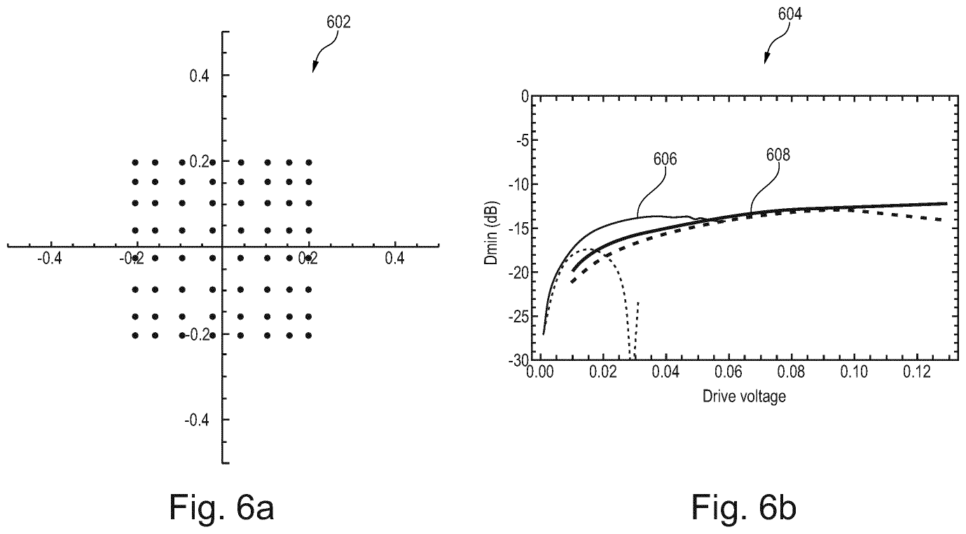

FIG. 6a illustrates a 64-QAM output 602 of the IQ modulator superstructure 400, with golden ring configuration, balanced drives (r>1) and a dc offset of 64% of the peak-to-peak the drive voltage. FIG. 6b illustrates performance of the superstructure 400 with golden ring configuration (a=t=0.9, r=−1) with offset optimised for each drive voltage (solid) and a fixed offset (dashed), and with silver configuration (a=0.9, t=0.8) with optimised scaling co-efficient for each drive voltage (solid) and a fixed scaling co-efficient (dashed).

When r=1, the phase modulation is perfectly cancelled by the second ring in each arm. At r=1, the transfer function of each arm of the structure 400 becomes

$$\frac{{a}^{2} + {t}^{2} - 2 a t Cos ( π v )}{1 + {a}^{2} {t}^{2} - 2 a t Cos ( π v )} \qquad ( 3 )$$

which is always positive and unchirped (suitable for PAM modulation), has maximum extinction ratio for “golden ring” configurations (a=t) and an output power increasing with the transmittance of the ring.

It can be seen that the proposed structure 400 with golden ring configuration offers a performance comparable to that of a conventional MZM and greatly exceeds the single RR configuration, whilst retaining the size and modulation advantages of the RR modulator. The proposed structure 400 operates with a low drive voltage and presents a small residual chirp. Further, the proposed structure 400 has a sinusoidal transfer function like a conventional dual parallel MZM, the transfer function is sinusoidal, and a dc bias is required for a uniform constellation.

The proposed superstructure 400 with golden ring configuration produces a chirp free waveform, but in common with conventional MZMs (straight waveguides), the sinusoidal output drives a trade-off between distortion and output power.

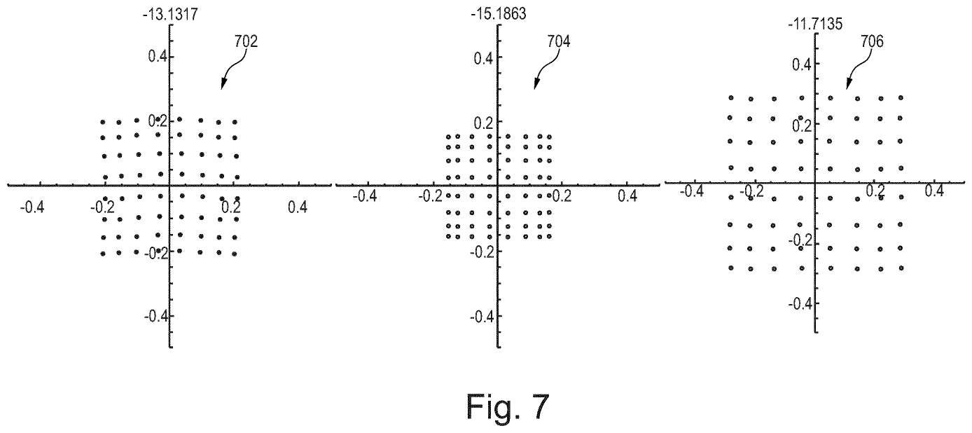

FIG. 7 illustrates constellation diagrams 702, 704 and 706 for the superstructure 420 with silver ring configuration, i.e. a and t equal to {0.9, 0.8}, {0.95, 0.6} and {0.6, 0.4} respectively, and captions at the head of the y axis represent 10 log₁₀ (minimum distance).It can be seen that similar overall performance to conventional MZMs is achieved, with a more uniformly spaced constellation offsetting the slightly reduced output power.

Thus, compared to conventional MZM, the proposed structure 400 with silver ring configuration offer comparable performance, with linear modulation, but slightly reduced output power.

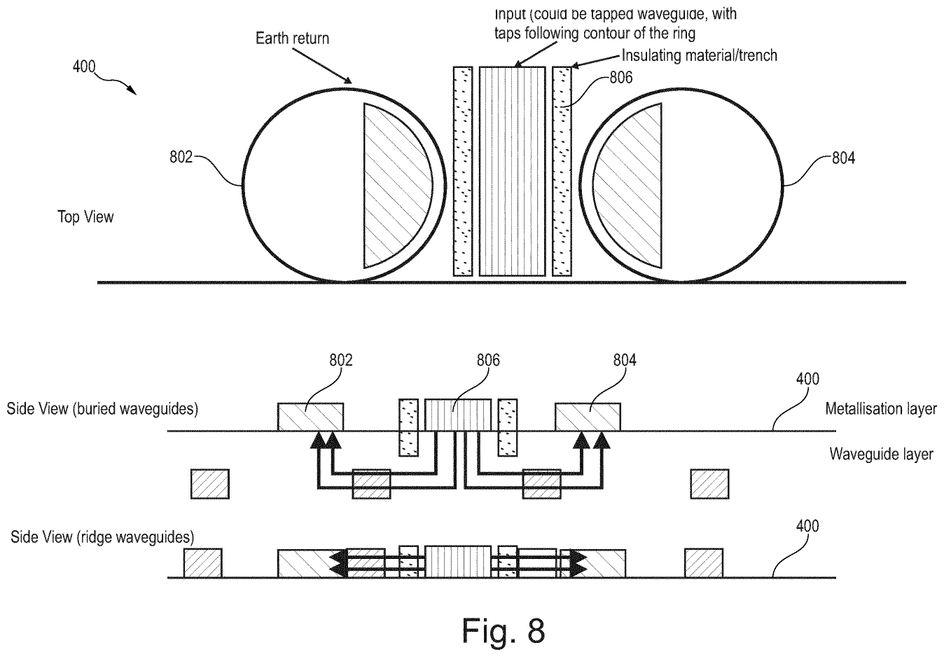

FIG. 8 illustrates top and side views of one proposed implementation of the IQ modulator superstructure 400, in push pull configuration (assuming correct crystal orientation and Kerr effect-based modulation mechanism). The IQ modulator superstructure 400 may be formed from a trigonal crystal structure such as lithium niobate.

The top view illustrates first and second ring modulators 802 and 804 (similar to the first top and bottom ring modulators 402 and 406), and a middle arm 806 which could be a tapered waveguide with taps following the contour of the rings 802 and 804. In an embodiment of the present invention, in addition to the drive voltages, it may be necessary to apply a DC bias to each of the ring modulators 802 and 804. The value of the DC bias would be dependent on the exact waveguide dimensions and the signal wavelength. The DC bias could be applied using an electrical bias T, or via separate electrodes on each of the ring modulators 802 and 804. For example, the output of the drive amplifier for each arm of the RR MZM could drive a central electrode between the rings (red), bordered by insulating material (which could be air, where the structure a trench, or resist, or an undoped semiconductor material). Earth returns could be provided by electrodes inside each ring (brown). In the case of a buried waveguide, electric fields would pass through the material below the waveguide from the central electrode to the earth returns, passing through part of the optical waveguide. For a correctly orientated crystal structure, the sign of the phase shift induced by the electric field would depend on the direction of the field, so giving the required push pull effect. Adjusting the earth electrode lengths would enable r to be tuned with optimised waveguide loss to maximise linearity.

The couplers shown in 400 can be configured to have a coupling ratio in order to provide the correct dc offset without needing an amplitude control (another ring) in the third arm. This can be derivable from the formula above (B/7/(1+j)).

In the specification the terms “comprise, comprises, comprised and comprising” or any variation thereof and the terms include, includes, included and including” or any variation thereof are considered to be totally interchangeable, and they should all be afforded the widest possible interpretation and vice versa.

The invention is not limited to the embodiments hereinbefore described but may be varied in both construction and detail.

1. A cascaded ring resonator structure, comprising:
a pair of identical ring modulators connected in series, each ring modulator of the pair being driven by first and second drive voltages respectively for generating a chirp-free output signal, and wherein the first and second drive voltages have opposite polarities and are in a predetermined ratio.

2. The cascaded ring resonator structure as claimed in claim 1, wherein the pre-determined ratio is greater than 0 and less than or equal to 1.

3. The cascaded ring resonator as claimed in any preceding claim, wherein the pair of identical ring modulators operate in an ideal push-pull configuration, when the pre-determined ratio is one.

4. The cascaded ring resonator as claimed in any preceding claim, wherein each ring modulator of the pair operate in a golden ring configuration, when corresponding absorption co-efficient is similar to corresponding ring coupling efficient.

5. The cascaded ring resonator as claimed in any preceding claim, wherein each ring modulator of the pair operate in a silver ring configuration, when absorption co-efficient of each of the first through fourth ring modulators is greater than corresponding ring coupling efficient.

6. An IQ modulator superstructure, comprising:
an upper arm including a cascaded ring resonator structure as claimed in any of claims 1 to 5, and driven by in-phase components of first and second drive voltages for generating a chirp-free in-phase output signal; and
a lower arm including the cascaded ring resonator structure as claimed in claims 1-5, and driven by quadrature components of first and second drive voltages for generating a chirp-free quadrature output signal,
wherein the in-phase and quadrature output signals combine to generate a chirp-free rectangular QAM signal.

7. The IQ modulator superstructure as claimed in claim 6 further comprising a third unmodulated arm between the upper and lower arms, to provide a DC bias to negate a DC offset of the chirp-free rectangular QAM signal, and centre a constellation diagram of the chirp-free QAM signal on the origin.

8. The IQ modulator superstructure as claimed in claim 7, wherein the third unmodulated arm comprises a passive waveguide and a phase shifter.

9. The IQ modulator superstructure as claimed in claim 7, wherein the ring coupling co-efficients of the cascaded ring resonators of the upper and lower arms are tuned to generate a desired amplitude of the rectangular QAM signal.

10. The IQ modulator superstructure as claimed in claim 7, wherein the third arm includes a single ring to modulate an amplitude of the chirp-free rectangular QAM signal.
